(19) United States
(12) Patent Application Publication
(10) Pub. No.: US 2016/0072876 A1
(43) Pub. Date: Mar. 10, 2016

(54) GENERATING DIGITAL MEDIA

(71) Applicant: Google Inc., Mountain View, CA (US)

(72) Inventors: David Louis Bergman QUAID, San Francisco, CA (US); Devin SANDOZ, San Francisco, CA (US); Shalom SABAG, Hoboken, NJ (US); Vijay Paul SINGH, Brooklyn, NY (US); Francois DE HALLEUX, San Francisco, CA (US)

(73) Assignee: GOOGLE INC., Mountain View, CA (US)

(21) Appl. No.: 14/064,162

(22) Filed: Oct. 27, 2013

(51) Int. Cl. H04L 29/08

(52) U.S. Cl. CPC H04L 67/10

(57) ABSTRACT

Implementations generally relate to generating digital media. In some implementations, a method includes receiving one or more non-digital media items from a user. The method further includes generating one or more digital media items from the one or more non-digital media items. The method further includes storing the one or more digital media items in a storage location associated with the user. The method also includes enabling the user to share the one or more digital media items from the storage location.

### BACKGROUND

Social network systems often enable users to upload media content such as digital photos, and enable users to create photo albums. Social network systems also enable users to share photos with each other. For example, users can share photos with friends and family, which provides enjoyable and bonding experiences among users of a social network system. Many users have non-digital photos that cannot be shared digitally (e.g., via a social network) unless the non-digital photos are digitized. A user can digitize a photo by scanning the photo, which can be difficult if the user does not have convenient access to a scanner, or if the user does not have time to scan photos.

### SUMMARY

Implementations generally relate to generating digital media. In some implementations, a method includes receiving one or more non-digital media items from a user. The method also includes generating one or more digital media items from the one or more non-digital media items. The method further includes storing the one or more digital media items in a storage location associated with the user. The method further includes enabling the user to share the one or more digital media items from the storage location.

With further regard to the method, in some implementations, the non-digital media items are photos. In some implementations, the method further includes verifying that the one or more received non-digital media items were sent by the user. In some implementations, the method further includes verifying that the one or more received non-digital media items were sent by the user, where the verifying includes verifying a barcode on a mailer against an account associated with the user, and where the one or more received non-digital media items are received in the mailer. In some implementations, the method further includes verifying that the one or more received non-digital media items were sent by the user, where the verifying is based on a token generated in response to a request from the user to digitize non-digital media. In some implementations, the method further includes verifying that the one or more received non-digital media items were sent by the user, where the verifying includes matching a first copy of a token that is encoded in a barcode on a mailer with a second copy of the token stored in association with the user, and where the one or more received non-digital media items are received in the mailer. In some implementations, the method further includes verifying that the received non-digital media items were sent by the user, where the verifying includes: authenticating the user when the user logs into an account associated with the user; generating a token in response to receiving a request from the user to digitize non-digital media; sending a mailer to the user, where the mailer includes a barcode that is encoded with a first copy of the token; storing a second copy of the token in association with the account associated with the user; receiving the one or more non-digital media items in the mailer; and matching the first copy of the token with the second copy of the token. In some implementations, the storage location associated with the user is accessible by the user. In some implementations, the method further includes sending the one or more non-digital media items back to the user after generating the one or more digital media items from the one or more non-digital media items.

In some implementations, a method includes receiving one or more non-digital media items from a user, where the non-digital media items are photos. The method further includes verifying that the one or more received non-digital media items were sent by the user. The method further includes generating one or more digital media items from the one or more non-digital media items. The method further includes storing the one or more digital media items in a storage location associated with the user.

With further regard to the method, in some implementations, the verifying includes verifying a barcode on a mailer against an account associated with the user, and where the one or more received non-digital media items are received in the mailer. In some implementations, the storage location associated with the user is accessible by the user. In some implementations, the method further includes sending the one or more non-digital media items back to the user after generating the one or more digital media items from the one or more non-digital media items.

In some implementations, a system includes one or more processors, and logic encoded in one or more tangible media for execution by the one or more processors. When executed, the logic is operable to perform operations including: receiving one or more non-digital media items from a user; generating one or more digital media items from the one or more non-digital media items; storing the one or more digital media items in a storage location associated with the user; and enabling the user to share the one or more digital media items from the storage location.

With further regard to the system, in some implementations, the non-digital media items are photos. In some implementations, the logic when executed is further operable to perform operations including verifying that the one or more received non-digital media items were sent by the user. In some implementations, the logic when executed is further operable to perform operations including verifying that the one or more received non-digital media items were sent by the user, where the verifying includes verifying a barcode on a mailer against an account associated with the user, and where the one or more received non-digital media items are received in the mailer. In some implementations, the logic when executed is further operable to perform operations including verifying that the one or more received non-digital media items were sent by the user, where the verifying is based on a token generated in response to a request from the user to digitize non-digital media. In some implementations, the logic when executed is further operable to perform operations including verifying that the one or more received non-digital media items were sent by the user, where the verifying includes matching a first copy of a token that is encoded in a barcode on a mailer with a second copy of the token stored in association with the user, and where the one or more received non-digital media items are received in the mailer.

### BRIEF DESCRIPTION OF THE DRAWINGS

FIG. 1 illustrates a block diagram of an example network environment, which may be used to implement the implementations described herein.

FIG. 2 illustrates an example simplified flow diagram for providing a mailer to a user, according to some implementations.

FIG. 3 illustrates an example simplified flow diagram for generating digital media, according to some implementations.

FIG. 4 illustrates a block diagram of an example server device, which may be used to implement the implementations described herein.

### DETAILED DESCRIPTION

Implementations for generating digital media items are described. In various implementations, a system receives one or more non-digital media items from a user. For example, in some implementations, the non-digital media items may be non-digitized physical photos. In various implementations, the system verifies that the one or more received non-digital media items were sent by the user. The system then generates one or more digital media items from the one or more non-digital media items. The system then stores the one or more digital media items in a storage location associated with the user. In some implementations, the storage location associated with the user is accessible by the user. The system sends the one or more non-digital media items back to the user after generating the one or more digital media items from the one or more non-digital media items.

As described in more detail below, in some implementations, to verify that the one or more received non-digital media items were sent by the user, the system verifies a barcode on a mailer against an account associated with the user, and where the one or more received non-digital media items are received in the mailer. In some implementations, the system may verify that the one or more received non-digital media items were sent by the user, where the verifying is based on a token generated in response to a request from the user to digitize non-digital media. In some implementations, to verify that the one or more received non-digital media items were sent by the user, the system may match a first copy of a token that is encoded in a barcode on a mailer with a second copy of the token stored in association with the user, and where the one or more received non-digital media items are received in the mailer.

In some implementations, to verify that the one or more received non-digital media items were sent by the user, the system may authenticate the user when the user logs into an account associated with the user, and may generate a token in response to receiving a request from the user to digitize non-digital media. The system then sends a mailer to the user, where the mailer includes a barcode that is encoded with a first copy of the token. The system then stores a second copy of the token in association with the account associated with the user. Upon receiving the one or more non-digital media items in the mailer, the system matches the first copy of the token with the second copy of the token.

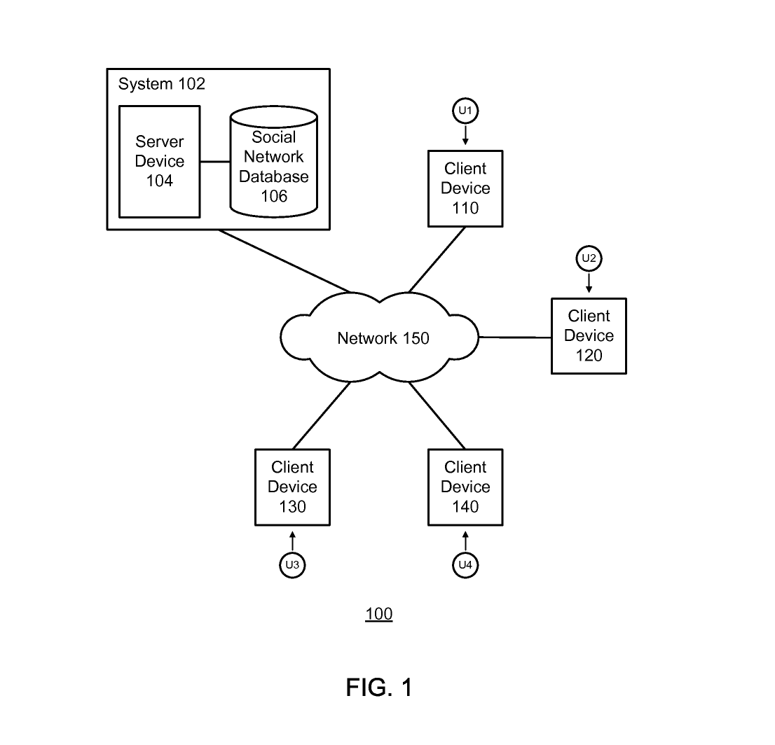

FIG. 1 illustrates a block diagram of an example network environment 100, which may be used to implement the implementations described herein. In some implementations, network environment 100 includes a system 102, which includes a server device 104 and a social network database 106. In various implementations, the term system 102 and phrase “social network system” may be used interchangeably. Network environment 100 also includes client devices 110, 120, 130, and 140, which may communicate with each other via system 102. Network environment 100 also includes a network 150.

For ease of illustration, FIG. 1 shows one block for each of system 102, server device 104, and social network database 106, and shows four blocks for client devices 110, 120, 130, and 140. Blocks 102, 104, and 106 may represent multiple systems, server devices, and social network databases. Also, there may be any number of client devices. In other implementations, network environment 100 may not have all of the components shown and/or may have other elements including other types of elements instead of, or in addition to, those shown herein.

In various implementations, users U1, U2, U3, and U4 may communicate with system 102 and with each other using respective client devices 110, 120, 130, and 140. Users U1, U2, U3, and U4 may interact with each other in order to digitize photos. Users U1, U2, U3, and U4 may also interact with each other to share the digitized photos.

In the various implementations described herein, processor of system 102 causes the elements described herein (e.g., digitized photos, etc.) to be displayed in a user interface on one or more display screens.

While some implementations are described herein in the context of a social network system, these implementations may apply in contexts other than a social network. For example, implementations may apply locally for an individual user. For example, system 102 may perform the implementations described herein on a stand-alone computer, tablet computer, smartphone, etc., where the user uses a stand-alone computer, tablet computer, smartphone, etc., to both initiate a photo digitizing process (e.g., requesting a mailer, etc.) and to receive resulting digitized photos (e.g., via the Internet/user's online account).

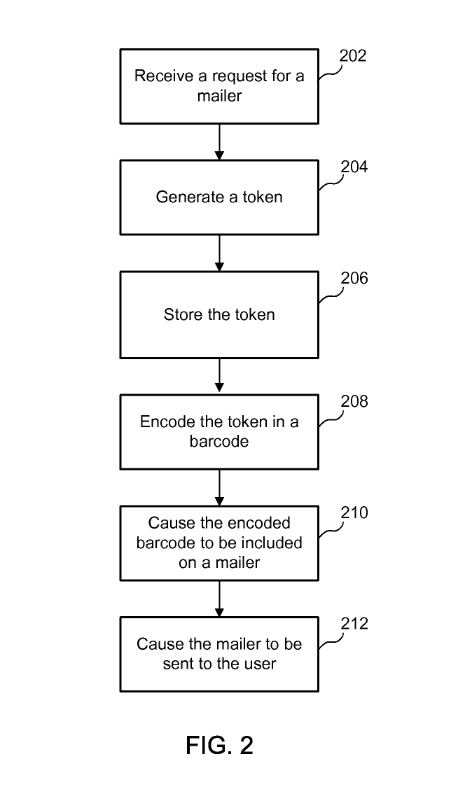

FIG. 2 illustrates an example simplified flow diagram for providing a mailer to a user, according to some implementations. Referring to both FIGS. 1 and 2, a method is initiated in block 202, where system 102 receives from the user a request for a mailer. In various implementations, the user requests the mailer after system 102 authenticates the user upon the user logging in via a user interface. In various implementations, system 102 may enable the user to request the mailer using any suitable user device (e.g., computer, computer tablet, smartphone, etc.).

In block 204, system 102 generates a token in response to receiving the mailer request. In some implementations the token may be referred to as a secret token, as the user need not be aware of the token. In various implementations, system 102 generates one token per mailer request. As such, each mailer is customized for a particular set or package of non-digital media items.

In block 206, system 102 stores the token in a storage location associated with the user's account. In block 208, system 102 encodes the token in a barcode. In block 210, system 102 causes the encoded barcode to be included on the mailer. In various implementations, various types of barcodes may be used (e.g., standard barcodes, QR barcodes, etc.). In some implementations, the barcode identifies the destination account (e.g., the requesting user's account).

In block 212, system 102 causes the mailer to be sent to the user. In some implementations, system 102 generates a mailer to be sent out to the user. In some implementations, system 102 generates a mailer label that includes the encoded barcode; and system 102 enables the user to print out the mailer label to be attached to user-provided packaging.

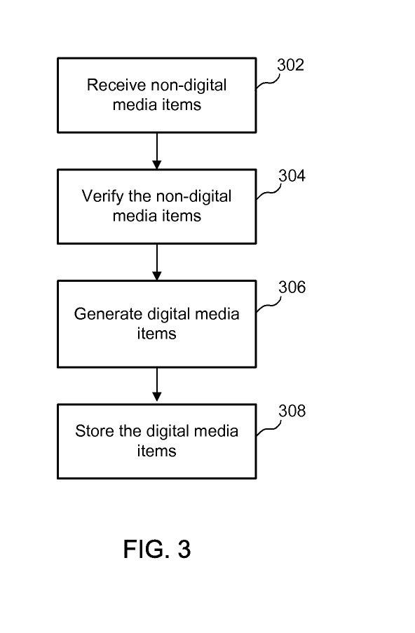

FIG. 3 illustrates an example simplified flow diagram for generating digital media, according to some implementations. Referring to both FIGS. 1 and 2, a method is initiated in block 302, where system 102 receives one or more non-digital media items from a user. In various implementations, the non-digital media items are photos. While some implementations herein are described in the context of photos, such implementations and others may also apply to not-photo media such as video or non-digital home movies, non-digital audio, artwork, hand drawn design, etc. In various implementations, system 102 receives the non-digital media items in a mailer sent by the user. As indicated above, in various implementations, the mailer was provided to the user by system 102.

In block 304, system 102 verifies that the one or more received non-digital media items were sent by the user. Verifying that the received non-digital media items were sent by the user ensures that another person does not inappropriately (e.g., maliciously, etc.) send in non-digital media items for digitizing. In various implementations, the user authorizes or delegates permission to system 102 to digitize the non-digital media items. Verifying that the received non-digital media items were sent by the user ensures that system 102 is authorized to digitize the received non-digital media items. System 102 uses the token embedded in the barcode as authentication that the account owner is giving system 102 permission to scan the non-digital media items.

As indicated above, in some implements, system 102 may encode a token in the barcode of the mailer, and may also store a copy of the token in a storage location associated with the user's account. System 102 may verify that the received non-digital media items were sent by the user by matching the token encoded in the barcode with the copy of the token stored in association with the user's account. Other implementations directed to verification are described in more detail below.

In some implementations, system 102 may enable a user to generate his or her own one-time-use password in the form of a barcode for his or her account. In some implementations, the one-time-use passwords may be achieved without the use of a secret token. For example, system 102 may embed the user's credentials in a barcode, or may enable the user to provide a user-printed form from a signup process with system 102 as a means of authentication.

In block 306, system 102 generates one or more digital media items from the one or more non-digital media items. For example, as described in more detail below, system 102 may scan non-digital photos and then convert the non-digital photos to digital photos. In various implementations, system 102 causes the received non-digital media items (e.g., photos) to be scanned once the bar code is verified. In some implementations, system 102 may enable a scan center to scan the photos. System 102 may then generate digital media items from the non-digital media items. In some implementations, system 102 may enable any suitable scan center, including third-party scan centers to scan the non-digital media items. In various implementations, the scan center first receives authorization from system 102 (e.g., after verification) before executing the scanning.

In block 308, system 102 stores the one or more digital media items in a storage location associated with the user. In some implementations, system 102 uploads the digital media items to a storage location associated with an existing account controlled by the user.

In some implementations, system 102 may enable the user to indicate date ranges for different sets of non-digital media items (e.g., photos). System 102 may provide different barcodes for each set. As such, system 102 may then scan the photos into the users' account applying those timestamps. In some implementations, system 102 may also divide media items (e.g., photos) by album if the user desires.

In block 310, system 102 enables the user to share the one or more digital media items from the storage location. In various implementations, the storage location associated with the user is accessible by the user; for example, where system 102 uploads the digital media items to a storage location associated with an existing account controlled by the user. In some implementations, system 102 notifies the user when the digitized media items have been uploaded to the storage space. The user can then organize the media items and/or share such media items with other users.

In various implementations, system 102 sends the one or more non-digital media items (e.g., photos) back to the user after generating the one or more digital media items from the one or more non-digital media items. In some implementations, if a scan center scans the non-digital media items, the scan center sends the non-digital media items back to the user.

As indicated above, system 102 verifies that the one or more received non-digital media items were sent by the user. The following are example implementations associated with verifying that the one or more received non-digital media items were sent by the user. For example, in some implementations, system 102 verifies a barcode on a mailer against an account associated with the user, and where the one or more received non-digital media items are received in the mailer.

In various implementations, system 102 verifies that the one or more received non-digital media items were sent by the user based on a token generated in response to a request from the user to digitize non-digital media.

In some implementations, to verify that the one or more received non-digital media items were sent by the user, system 102 matches a first copy of a token that is encoded in a barcode on a mailer with a second copy of the token stored in association with the user, and where the one or more received non-digital media items are received in the mailer.

In some implementations, to verify that the one or more received non-digital media items were sent by the user, system 102 authenticates the user when the user logs into an account associated with the user. System 102 then generates a token in response to receiving a request from the user to digitize non-digital media. System 102 then sends a mailer to the user, where the mailer includes a barcode that is encoded with a first copy of the token. System 102 then stores a second copy of the token in association with the account associated with the user. System 102 then receives the one or more non-digital media items in the mailer. System 102 then matches the first copy of the token with the second copy of the token.

Implementations described herein provide various benefits. For example, verification ensures that that media items received to digitize are received from the appropriate user. Implementations enable users to have and share more media items with other users. Implementations described herein also increase overall engagement among users in a social networking environment.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

While system 102 is described as performing the steps as described in the implementations herein, any suitable component or combination of components of system 102 or any suitable processor or processors associated with system 102 may perform the steps described.

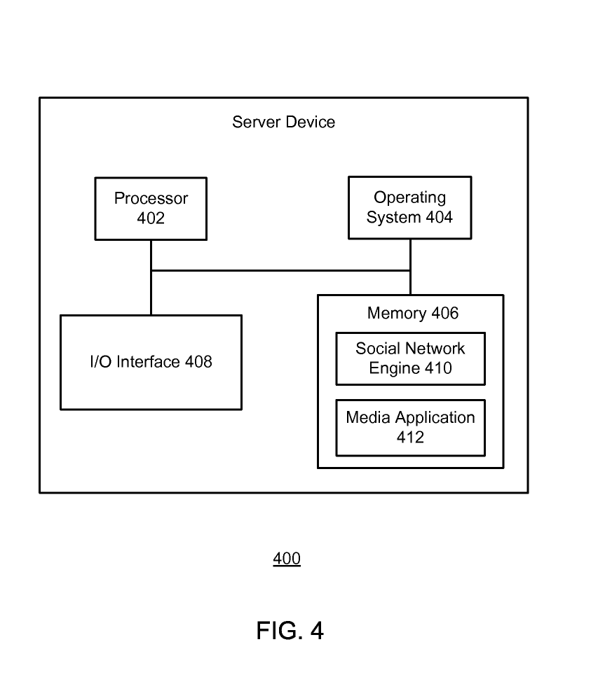

FIG. 4 illustrates a block diagram of an example server device 400, which may be used to implement the implementations described herein. For example, server device 400 may be used to implement server device 104 of FIG. 1, as well as to perform the method implementations described herein. In some implementations, server device 400 includes a processor 402, an operating system 404, a memory 406, and an input/output (I/O) interface 408. Server device 400 also includes a social network engine 410 and a media application 412, which may be stored in memory 406 or on any other suitable storage location or computer-readable medium. Media application 412 provides instructions that enable processor 402 to perform the functions described herein and other functions.

For ease of illustration, FIG. 4 shows one block for each of processor 402, operating system 404, memory 406, I/O interface 408, social network engine 410, and media application 412. These blocks 402, 404, 406, 408, 410, and 412 may represent multiple processors, operating systems, memories, I/O interfaces, social network engines, and media applications. In other implementations, server device 400 may not have all of the components shown and/or may have other elements including other types of elements instead of, or in addition to, those shown herein.

Although the description has been described with respect to particular embodiments thereof, these particular embodiments are merely illustrative, and not restrictive. Concepts illustrated in the examples may be applied to other examples and implementations. For example, some implementations are described herein in the context of a social network system. However, the implementations described herein may apply in contexts other than a social network. For example, implementations may apply locally for an individual user.

Note that the functional blocks, methods, devices, and systems described in the present disclosure may be integrated or divided into different combinations of systems, devices, and functional blocks as would be known to those skilled in the art.

Any suitable programming languages and programming techniques may be used to implement the routines of particular embodiments. Different programming techniques may be employed such as procedural or object-oriented. The routines may execute on a single processing device or multiple processors. Although the steps, operations, or computations may be presented in a specific order, the order may be changed in different particular embodiments. In some particular embodiments, multiple steps shown as sequential in this specification may be performed at the same time.

A “processor” includes any suitable hardware and/or software system, mechanism or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions for execution by the processor. The software instructions can also be contained in, and provided as, an electronic signal, for example in the form of software as a service (SaaS) delivered from a server (e.g., a distributed system and/or a cloud computing system).

What is claimed is:

1. A method comprising:
receiving one or more non-digital media items from a user, wherein the non-digital media items are photos;
verifying that the one or more received non-digital media items were sent by the user;
generating one or more digital media items from the one or more non-digital media items; and
storing the one or more digital media items in a storage location associated with the user.

2. The method of claim 1, wherein the verifying includes verifying a barcode on a mailer against an account associated with the user, and wherein the one or more received non-digital media items are received in the mailer.

3. The method of claim 1, wherein the storage location associated with the user is accessible by the user.

4. The method of claim 1, further comprising sending the one or more non-digital media items back to the user after generating the one or more digital media items from the one or more non-digital media items.

5. A method comprising:
receiving one or more non-digital media items from a user;
generating one or more digital media items from the one or more non-digital media items;
storing the one or more digital media items in a storage location associated with the user; and
enabling the user to share the one or more digital media items from the storage location.

6. The method of claim 5, wherein the non-digital media items are photos.

7. The method of claim 5, further comprising verifying that the one or more received non-digital media items were sent by the user.

8. The method of claim 5, further comprising verifying that the one or more received non-digital media items were sent by the user, wherein the verifying includes verifying a barcode on a mailer against an account associated with the user, and wherein the one or more received non-digital media items are received in the mailer.

9. The method of claim 5, further comprising verifying that the one or more received non-digital media items were sent by the user, wherein the verifying is based on a token generated in response to a request from the user to digitize non-digital media.

10. The method of claim 5, further comprising verifying that the one or more received non-digital media items were sent by the user, wherein the verifying includes matching a first copy of a token that is encoded in a barcode on a mailer with a second copy of the token stored in association with the user, and wherein the one or more received non-digital media items are received in the mailer.

11. The method of claim 5, further comprising verifying that the received non-digital media items were sent by the user, wherein the verifying comprises:
authenticating the user when the user logs into an account associated with the user;
generating a token in response to receiving a request from the user to digitize non-digital media;
sending a mailer to the user, wherein the mailer includes a barcode that is encoded with a first copy of the token;
storing a second copy of the token in association with the account associated with the user;
receiving the one or more non-digital media items in the mailer; and
matching the first copy of the token with the second copy of the token.

12. The method of claim 5, wherein the storage location associated with the user is accessible by the user.

13. The method of claim 5, further comprising sending the one or more non-digital media items back to the user after generating the one or more digital media items from the one or more non-digital media items.

14. A system comprising:
one or more processors; and
logic encoded in one or more tangible media for execution by the one or more processors and when executed operable to perform operations comprising:
receiving one or more non-digital media items from a user;
generating one or more digital media items from the one or more non-digital media items;
storing the one or more digital media items in a storage location associated with the user; and
enabling the user to share the one or more digital media items from the storage location.

16. The system of claim 14, wherein the non-digital media items are photos.

17. The system of claim 14, wherein the logic when executed is further operable to perform operations comprising verifying that the one or more received non-digital media items were sent by the user.

18. The system of claim 14, wherein the logic when executed is further operable to perform operations comprising verifying that the one or more received non-digital media items were sent by the user, wherein the verifying includes verifying a barcode on a mailer against an account associated with the user, and wherein the one or more received non-digital media items are received in the mailer.

19. The system of claim 14, wherein the logic when executed is further operable to perform operations comprising verifying that the one or more received non-digital media items were sent by the user, wherein the verifying is based on a token generated in response to a request from the user to digitize non-digital media.

20. The system of claim 14, wherein the logic when executed is further operable to perform operations comprising verifying that the one or more received non-digital media items were sent by the user, wherein the verifying includes matching a first copy of a token that is encoded in a barcode on a mailer with a second copy of the token stored in association with the user, and wherein the one or more received non-digital media items are received in the mailer.
